(19) United States
(12) Patent Application Publication
(10) Pub. No.: US 2004/0073931 A1
(43) Pub. Date: Apr. 15, 2004

(54) Interactive bed display

(75) Inventors: Robert B. Trussell JR., Lexington, KY (US); Wesley W. Campbell, Lexington, KY (US)

Correspondence Address: MICHAEL BEST & FRIEDRICH, LLP, 100 E WISCONSIN AVENUE, MILWAUKEE, WI, 53202, US

(73) Assignee: Tempur World, Inc., Lexington, KY

(21) Appl. No.: 10/268,202

(22) Filed: Oct. 10, 2002

(51) Int. Cl. H04N 5/44; H04N 11/00; H04N 7/00; A47G 29/02; E06B 7/28; E04G 3/08; H04N 7/18

(52) U.S. Cl. 725/74; 725/78; 248/241; 348/725; 348/552

(57) ABSTRACT

An interactive bed display for use in a retail setting to provide product information to a person, the interactive bed display comprising a bed including a mattress adapted to support the person, and a self-contained audio/video unit positioned to encourage the person to lie on the mattress such that the person is in a position to experience the benefits of the mattress, wherein the self-contained audio/video unit includes multiple stored audio/video segments and is adapted to receive an input generated from the person on the mattress, and wherein the self-contained audio/video unit is adapted to deliver at least one of the multiple stored audio/video segments to the person on the mattress based on the input.

### FIELD OF THE INVENTION

This invention relates generally to displays, and more particularly to interactive displays.

### BACKGROUND OF THE INVENTION

Displays are commonly used to attract potential customers to a product. Often, the general purpose of displays is to make a visual statement. The statement may involve, among other things, attracting attention, spreading information, and encouraging the purchase of a product.

Most often, traditional displays often rely upon still graphics or still pictures to make their statement. However, with advancing technology and changing advertising trends, additional media has been introduced to supplement the still graphics or pictures of the traditional still displays. For example, such additional media can include audio tracks to supplement the still graphics or pictures of the traditional display, or can include some kind of graphical animation to enhance the visual aspects of the traditional displays, such as lenticular graphics or video tracks stored on a video cassette or a compact disc. However, even with the visual improvements to the traditional displays, the capabilities of the improved traditional displays are still somewhat limited in scope.

### SUMMARY OF THE INVENTION

With advanced computer video technology, it is possible to electronically store video tracks, still graphics, and audio tracks in computer memory. With this possibility, displays can now take advantage of the relatively small sizes and low costs of computers by integrating them into a display, thus enhancing the capabilities and presentation of the display.

By integrating computers into displays, the possibility of interactive displays exists. Using currently available software, a video track can be configured such that a person is allowed to interact with the story, or message, presented by the video track. For example, the person may interact with the message to select different topics within the message, or the person may interact with the story by selecting different options that may alter the outcome of the story.

It is the general object of this invention to provide an interactive bed display that addresses some of the problems found in the prior art. One embodiment of the interactive bed display includes a bed having a mattress to support a person, and a self-contained audio/video unit positioned to encourage the person to lie on the mattress such that the person is in a position to experience the benefits of the mattress, where the self-contained audio/video unit includes multiple stored audio/video segments and receives an input generated from the person on the mattress, and where the self-contained audio/video unit delivers at least one of the multiple stored audio/video segments to the person on the mattress based on the input.

Another embodiment of the interactive bed display includes a bed having a mattress to support a person, and a self-contained audio/video unit positioned to encourage the person to lie on the mattress such that the person is in a position to experience the benefits of the mattress, where the self-contained audio/video unit includes multiple stored audio/video segments and receives an input generated from the person on the mattress, and where the self-contained audio/video unit delivers at least one of the multiple stored audio/video segments to the person on the mattress based on the input, where the self-contained audio/video unit is positioned above the person and within reaching distance of the person while on the mattress, and where the self-contained audio/video unit includes a screen and the mattress includes a top surface, where the screen substantially faces the top surface of the mattress, and where the at least one of the multiple stored audio/video segments encourages the person to remain on the mattress during the course of the at least one of the multiple stored audio/video segments.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTI0N OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

FIG. 1 is a front perspective view of an interactive bed display embodying the present invention, the interactive bed display shown positioned on a bed above a person lying on the bed.

FIG. 2 is a rear perspective view of the interactive bed display of FIG. 1, illustrating a support arm connecting the interactive bed display to the bed.

FIG. 3a is a front view of an LCD touch screen of the interactive bed display of FIG. 1, illustrating a menu segment.

FIG. 3b is a rear view of a touch screen LCD unit of the interactive bed display of FIG. 1, illustrating individual components.

FIG. 4 is a schematic of an audio/video message delivered by the interactive bed display, including multiple segments therein.

### DETAILED DESCRIPTION OF THE PREFERRED EMBODIMENT

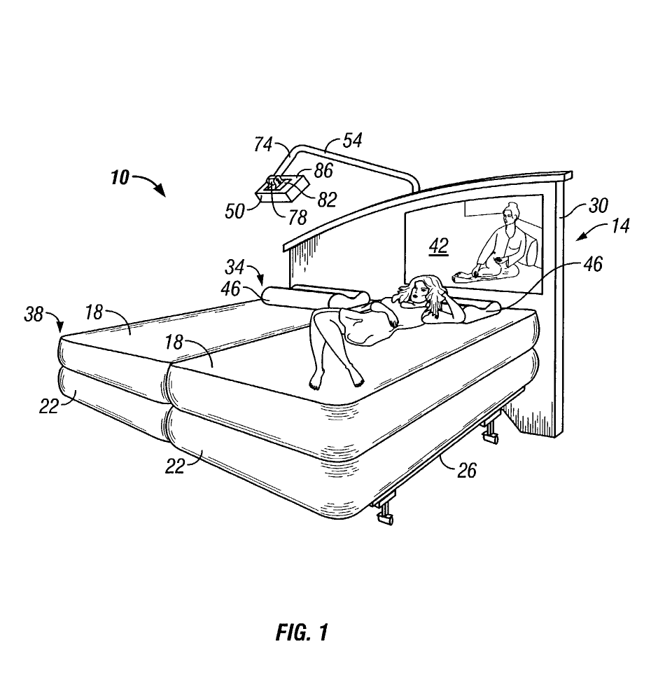

One embodiment of an interactive bed display 10 is shown in FIG. 1. The interactive bed display 10 includes a bed 14 having dual, twin size mattresses 18 and box springs 22 that are supported by a frame 26. A headboard 30 is mounted to the frame 26 using conventional fasteners at one end of the frame 26 to define a head portion 34, thereby defining the opposite end of the frame 26 as a foot portion 38. Alternatively, the bed 14 may include any size mattress 18 and box springs 22, including, among others, king, queen, and double size mattresses. Also, more than two mattresses 18 may be positioned directly adjacent each other to yield a combined bedding surface. Similarly, only one mattress 18 may be used. Also, the mattresses 18 can be used with or without the box springs 22.

A lenticular sign 42 is flush-mounted on the headboard 30 using conventional methods, such as using adhesive bonding or fasteners. The lenticular sign 42 displays multiple different images, depending on a person's viewing angle of the sign 42. The images generally depict different views of satisfied customers lying on the mattress 18 and experiencing the comfort and other advantages provided by the mattress 18. As the person walks by the bed 14, the displayed image changes depending on the viewing angle of the person. The images convey a message designed to entice the person to walk over to the bed 14 and lie on the mattress 18. It should be understood that “lying” on the mattress may also include sitting on the mattress, and any inclined position therebetween. Pillows 46 are further provided to enhance the person's comfort while on the mattress 18.

The lenticular sign 42 is not limited to the mounting illustrated in FIG. 1. The sign 42 may be mounted to the frame 26 of the bed 14, among other places, and may also be mounted to a separate structure from the bed 14. Also, the sign 42 may be positioned adjacent the bed 14 or above the bed 14. As a further alternative, the sign 42 may be cantilevered from the headboard 30, and may use any satisfactory structure to position the sign 42 relative to the headboard 30. Although the sign 42 is shown in the illustrated embodiment, the sign 42 is not required in all embodiments of the present invention.

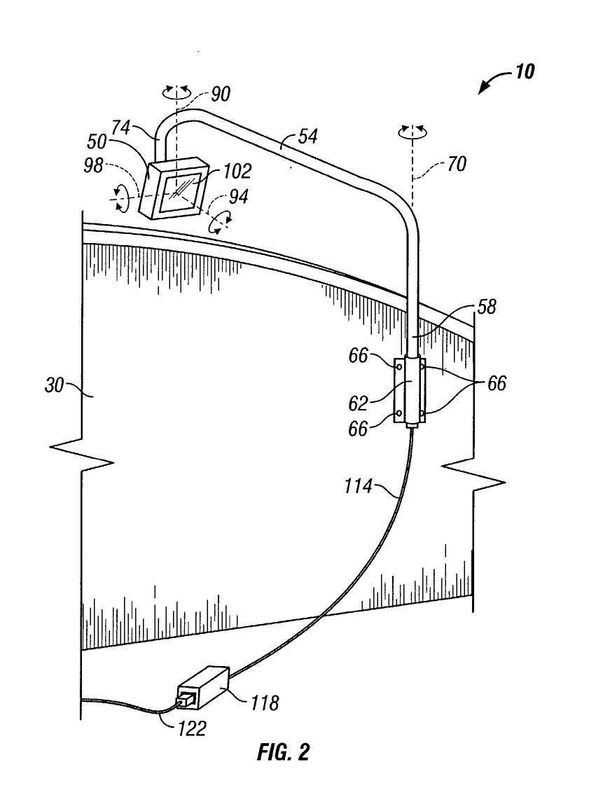

As shown in FIG. 1, an interactive, touch screen LCD unit 50 is coupled to the headboard 30 via a support arm 54 such that the LCD unit 50 is positioned above the person when the person is lying on the mattress 18. As shown in FIG. 2, the support arm 54 includes a headboard connecting end 58 that engages a bracket 62 mounted to the rear of the headboard 30 using conventional fasteners 66. The bracket 62 allows the support arm 54 to swivel about a central axis 70 and to vertically adjust along the central axis 70. Upon assembly to the headboard 30, the headboard connecting end 58 of the support arm 54 is vertically positioned in the bracket 62 such that the person lying on the mattress 18 can substantially reach the LCD unit 50 without sitting up. The fasteners 66 are then tightened, therefore affixing the vertical position of the support arm 54 within the bracket 62. However, the support arm 54 is still allowed to swivel within the bracket 62.

The support arm 54 further includes an LCD unit connecting end 74 having a multiple-degree of freedom joint 78 that connects with a receiving bracket 82 on a rear surface 86 of the LCD unit 50. A ball joint, among other types of joints 78 known to those of ordinary skill in the art, can be used as the multiple-degree of freedom joint 78. The joint 78 allows the LCD unit 50 to swivel about a first axis 90, rotate about a second axis 94, and tilt about a third axis 98. Swiveling, rotating, and tilting of the LCD unit 50 about the respective axes 90, 94, 98 and additionally swiveling the support arm 54 about the central axis 70, allows the person lying on the mattress 18 to adjust the position of the LCD unit 50 relative to the mattress 18 for ease of viewing.

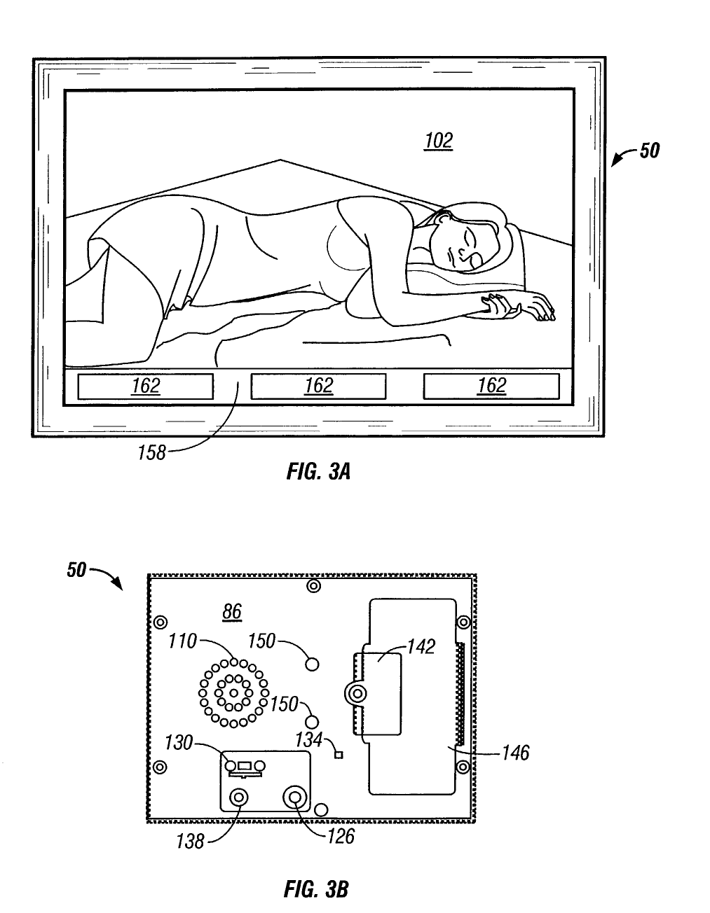

As shown in FIGS. 3a-3b, the LCD unit 50 includes a touch screen 102, which delivers the video portion of an audio/video message. In one embodiment, the touch screen 102 is about 6.4 viewable inches. The LCD unit 50 further includes a speaker module 110 which accordingly, delivers the audio portion of the audio/video message. As shown in FIG. 2, a power cord 114 supplies 12-volt DC current to the LCD unit 50, whereby the power cord 114 is routed through the support arm 54 and exits the support arm 54 at the headboard connecting end 58. The 12-volt DC current originates from a converter box 118, which is electrically connected to the power cord 114 and transforms the 10-volt AC line current into the 12-volt DC current that powers the LCD unit 50. The AC line current is carried to the converter box 118 via another power cord 122, which plugs into the converter box 118.

As shown in FIG. 3b, the power cord 114 plugs into a 12-volt DC input terminal 126 via an appropriate electrical terminal (not shown). An “on/off” power switch 130 activates and deactivates the LCD unit 50, while a power indicator LED 134 displays whether the LCD unit is “on” or “off.” When illuminated, the LED 134 indicates that the LCD unit 50 is “on.” A headphone jack 138 allows the person to listen to the audio portion of the audio/video message through headphones, rather than through the speaker module 110. When a pair of headphones or multiple pairs of headphones are plugged into the headphone jack 138, the speaker module 110 is deactivated. Accordingly, the volume of the speaker module 110 is adjustable to match the noise level of the display's environment.

The touch screen LCD unit 50 utilizes a solid state storage device, such as a compact flash card 142, to electronically store the audio/video message. Alternatively, any PCMCIA-type memory cards may be used to electronically store the audio/video message. Advantages of using the compact flash card 142 versus a hard disk, which is usually available with a higher storage capacity at a lower cost, include that the compact flash card 142 is noiseless (since there are no moving mechanical parts). Also, the compact flash card 142 allows faster access to the stored data. Physically, the compact flash card 142 is smaller and lighter in size when compared to a hard disk. These advantages allow the touch screen LCD unit 50 to deliver the audio/video message without any noise interference from the LCD unit 50 itself, as the data comprising the message is accessed. Also, the compact flash card 142 allows rapid access of the stored data, so that the audio/video message is delivered without lengthy pauses caused by data access. If a hard disk were used in place of the compact flash card 142, the excess noise emitted by the hard disk during operation might distract the person when viewing the audio/video message. Additionally, the lengthy pauses of data access associated with a hard disk may be longer than the attention span of the person viewing the audio/video message, thus distracting the person from concentrating on the message itself. As shown in FIG. 3b, the compact flash card 142 is positioned within the LCD unit 50 and protected by a security cover 146. Further, mounting holes 150 in the LCD unit 50 allow the receiving bracket 82 to be affixed to the LCD unit 50.

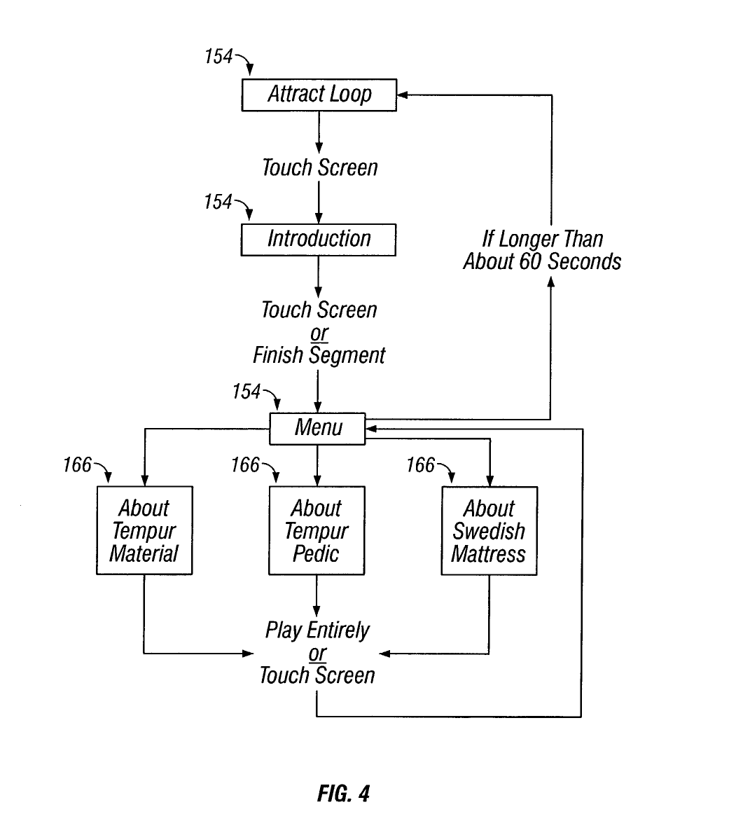

After the person has decided to lie on the mattress 18 and the LCD unit 50 is adjusted to suit the person, the person interacts with the touch screen LCD unit 50 to access the audio/video message, which is scripted to maintain the person lying on the mattress 18. As shown in FIG. 4, the audio/video message is structured having multiple segments 154. The first segment is an “attract loop,” which includes multiple images and text messages therein, where the images and text messages utilize a combination of scrolling, fading, and layering techniques to seize the person's attention once the person lies on the mattress 18. The attract loop plays continuously once the LCD unit 50 is turned on, and serves as the opening segment of the audio/video message. A text prompt within the attract loop instructs the person to proceed with the audio/video message by touching the screen 102.

Once the person touches the screen 102, the attract loop fades and the “introduction” segment begins. The introduction segment includes two individuals in dialogue that lasts between about five to ten minutes. The dialogue is scripted to convince the person to remain lying on the mattress 18 and to relax so that the person is able to receive all the benefits associated with the mattress 18. The dialogue also includes a portion explaining the technology and materials that provide the benefits of the mattress 18. This portion of the dialogue is delivered to the person while the person is experiencing the benefits of the mattress 18, so that the person learns and understands the technology and materials used in the mattress 18.

After completion of the introduction segment, or when the person interrupts the introduction segment by touching the screen 102 (thereby bypassing the balance of the introduction segment), the introduction segment fades and the “menu” segment appears. The menu segment is similar to the attract loop in that the menu segment includes multiple images therein, where the images utilize a combination of scrolling, fading, and layering techniques to present images of others experiencing the benefits of the mattress 18 and related products, such as pillows 46, lumbar supports, leg supports, and so forth. Generally, the menu segment is shown and depicted in FIG. 3a. A menu bar area 158 is shaded toward the bottom of the screen 102 to provide a distinct separation between the displayed image and the menu bar area 158. Multiple menu bars 162 are disposed within the menu bar area 158, whereby each menu bar 162 is operable to access a specific topic 166 within the audio/video message. The menu bars 162 include a brief text description of the respective specific topics 166 covered within the audio/video message. The LCD screen 102 will display the menu segment for about sixty seconds without any interaction from the person. After sixty seconds have past, and the person has not selected any of the menu bars 162, the audio/video message defaults back to the attract loop segment. If, however, the person does select one of the menu bars 162, the portion of the audio/video message that covers the specific topic 166 advertised by the respective menu bar 162 is accessed.

As shown in FIG. 3a, three menu bars 162 exist in the menu bar area 158 that correlate to the specific topics 166 shown in the schematic of FIG. 4. It should be understood that the specific topics 166 stated in FIG. 4 are only examples of such specific topics 166, and may include a plurality of specific topics 166 different from those stated in FIG. 4. To access one of the specific topics 166 within the audio/video message, the person lying on the mattress 18 touches one of the menu bars 162 on the LCD screen 102. Like the other segments 154, each specific topic 166 within the audio/video message is scripted to maintain the person lying in the mattress 18. After the portion of the audio/video message that covers the specific topic 166 is completed, or if the portion of the audio/video message is interrupted by the person touching the screen 102 (thereby bypassing the balance of the portion), the audio/video message defaults back to the menu segment. From the menu segment, the person lying on the mattress 18 may select any of the menu bars 162 on the LCD screen 102 to access the respective portions of the audio/video message. The person may choose to view the remaining specific topics 166, or may choose to repeat the previously viewed topic 166. When the person gets up from the mattress 18, without any user interaction for a pre-determined duration, the audio/video message defaults back to the attract loop, awaiting the next person to lie on the mattress 18 and view the message.

After viewing the audio/video message, the person should be more informed and educated regarding the technology and materials used in the mattress 18, and this knowledge, in combination with other factors, may help convince the person to purchase the mattress 18 in question.

We claim:

1. An interactive bed display to provide information to a person, the interactive bed display comprising:
a bed including a mattress adapted to support the person; and
a self-contained audio/video unit positioned to encourage the person to lie on the mattress such that the person is in a position to experience the mattress, wherein the self-contained audio/video unit includes multiple stored audio/video segments and is adapted to receive an input generated from the person on the mattress, and wherein the self-contained audio/video unit is adapted to deliver at least one of the multiple stored audio/video segments to the person on the mattress based on the input.

2. The interactive bed display of claim 1, further comprising a support arm coupling the self-contained audio/video unit to the bed, wherein the arm is adjustable to move the position of the self-contained audio/video unit relative to the bed.

3. The interactive bed display of claim 1, wherein the self-contained audio/video unit is positioned above the person and within reaching distance of the person while on the mattress.

4. The interactive bed display of claim 2, wherein the bed includes a headboard at one end of the mattress, and wherein the support arm is coupled to the headboard.

5. The interactive bed display of claim 1, wherein the self-contained audio/video unit includes a screen and the mattress includes a top surface, and wherein the screen substantially faces the top surface of the mattress.

6. The interactive bed display of claim 5, wherein the screen is adapted to generate a signal in response to the input from the person and to deliver a video portion of the at least one of the multiple stored audio/video segments to the person.

7. The interactive bed display of claim 6, wherein the input includes the person touching the screen.

8. The interactive bed display of claim 6, wherein the self-contained audio/video unit further comprises:
a sound system adapted to deliver an audio portion of the at least one of the multiple stored audio/video segments to the person; and
a controller adapted to coordinate the video player and sound system in response to the signal generated by the screen.

9. The interactive bed display of claim 6, wherein the screen is a touch screen LCD panel.

10. The interactive bed display of claim 1, wherein the at least one of the multiple stored audio/video segments encourages the person to remain on the mattress during the course of the at least one of the multiple stored audio/video segments.

11. The interactive bed display of claim 1, wherein each of the multiple stored audio/video segments is different from the other stored audio/video segments.

12. The interactive bed display of claim 11, wherein the at least one of the multiple stored audio/video segments includes information relating to the advantages of the mattress.

13. The interactive bed display of claim 1, wherein the bed includes a headboard at one end of the mattress, the headboard including a lenticular sign to attract the person to the bed.

14. A method of presenting a mattress, comprising:
providing a bed including a mattress to support a person;
providing a self-contained audio/video unit;
positioning the audio/video unit relative to the bed;
positioning the person onto the mattress;
receiving an input from the person while the person is supported on the mattress; and
delivering multiple stored audio/video segments from the audio/video unit to the person on the mattress in response to the input.

15. The method of claim 14, further comprising providing a support arm coupling the self-contained audio/video unit to the bed; and adjusting the support arm to move the self-contained audio/video unit relative to the bed.

16. The method of claim 14, further comprising positioning the self-contained audio/video unit above the person within reaching distance of the person on the mattress.

17. The method of claim 14, wherein positioning the person includes inviting the person to lie on the bed with a lenticular sign on the bed.

18. The method of claim 14, wherein receiving an input includes touching the screen.

19. The method of claim 14, further comprising generating a signal in response to the input to deliver at least one of the segments to the person.

20. The method of claim 14, wherein delivering the multiple stored audio/video segments includes delivering segments encouraging the person to remain on the mattress during the course of at least one of the segments.

21. The method of claim 14, wherein delivering the multiple stored audio/video segments includes delivering at least one segment relating to the advantages of the mattress.

22. An interactive bed display for use in a retail setting to provide product information to a person, the interactive bed display comprising:
a bed including a mattress adapted to support the person; and
a self-contained audio/video unit positioned to encourage the person to lie on the mattress such that the person is in a position to experience the benefits of the mattress, wherein the self-contained audio/video unit includes multiple stored audio/video segments and is adapted to receive an input generated from the person on the mattress, and wherein the self-contained audio/video unit is adapted to deliver at least one of the multiple stored audio/video segments to the person on the mattress based on the input;
wherein the self-contained audio/video unit is positioned above the person and within reaching distance of the person while on the mattress;
wherein the self-contained audio/video unit includes a screen and the mattress includes a top surface, and wherein the screen substantially faces the top surface of the mattress; and
wherein the at least one of the multiple stored audio/video segments encourages the person to remain on the mattress during the course of the at least one of the multiple stored audio/video segments.

23. An interactive bed display providing an interactive unit positioned to permit interaction with a person in a prone position on the bed, the interactive bed display comprising:
a bed including a mattress adapted to support the person; and
a self-contained audio/video unit positioned to encourage the person to lie on the mattress such that the person is in a position to experience the mattress, wherein the self-contained audio/video unit includes multiple stored audio/video segments and is adapted to receive an input generated from the person on the mattress, and wherein the self-contained audio/video unit is adapted to deliver at least one of the multiple stored audio/video segments to the person on the mattress based on the input.
